(19) United States
(12) Patent Application Publication
(10) Pub. No.: US 2009/0110267 A1
(43) Pub. Date: Apr. 30, 2009

(54) Automated texture mapping system for 3D models

(75) Inventors: Avidoh Zakhor, Berkeley, CA (US); Min Ding, Vancouver (CA)

Correspondence Address: Trellis Intellectual Property Law Group, PC, 1900 EMBARCADERO ROAD, SUITE 109, PALO ALTO, CA, 94303, US

(73) Assignee: The Regents of the University of California, Oakland, CA (US)

(21) Appl. No.: 12/229,919

(22) Filed: Aug. 28, 2008

Related U.S. Application Data
(60) Provisional application No. 60/974,307, filed on Sep. 21, 2007.

(51) Int. Cl. G06K 9/00

(52) U.S. Cl. 382/154

(57) ABSTRACT

A camera pose may be determined automatically and is used to map texture onto a 3D model based on an aerial image. In one embodiment, an aerial image of an area is first determined. A 3D model of the area is also determined, but does not have texture mapped on it. To map texture from the aerial image onto the 3D model, a camera pose is determined automatically. Features of the aerial image and 3D model may be analyzed to find corresponding features in the aerial image and the 3D model. In one example, a coarse camera pose estimation is determined that is then refined into a fine camera pose estimation. The fine camera pose estimation may be determined based on the analysis of the features. When the fine camera pose is determined, it is used to map texture onto the 3D model based on the aerial image.

### CROSS REFERENCES TO RELATED APPLICATIONS

This application claims priority from U.S. Provisional Patent Application Ser. No. 60/974,307, entitled “AUTOMATED TEXTURE MAPPING SYSTEM FOR 3D MODELS”, filed on Sep. 21, 2007, which is hereby incorporated by reference as if set forth in full in this application for all purposes.

### ACKNOWLEDGEMENT OF GOVERNMENT SUPPORT

This invention was made with Government support under Office of Naval Research Grand No. W911NF-06-1-0076. The Government has certain rights to this invention.

### BACKGROUND

Particular embodiments generally relate to a texture mapping system.

Textured three-dimensional (3D) models are needed in many applications, such as city planning, 3D mapping, photorealistic fly and drive-thrus of urban environments, etc. 3D model geometries are generated from stereo aerial photographs or range sensors such as LIDARS (light detection and ranging). The mapping of textures from aerial images onto the 3D models is manually performed using the correspondence between landmark features in the 3D model and the 2D imagery from the aerial image. This involves a human operator visually analyzing the features. This is extremely time-consuming and does not scale to large regions.

### SUMMARY

Particular embodiments generally relate to automatically mapping texture onto 3D models. A camera pose may be determined automatically and is used to map texture onto a 3D model based on an aerial image. In one embodiment, an aerial image of an area is first determined. The aerial image may be an image taken of a portion of a city or other area that includes structures such as buildings. A 3D model of the area is also determined, but does not have texture mapped on it.

To map texture from the aerial image onto the 3D model, a camera pose is needed. Particular embodiments determine the camera pose automatically. For example, features of the aerial image and 3D model may be analyzed to find corresponding features in the aerial image and the 3D model. In one example, a coarse camera pose estimation is determined that is then refined into a fine camera pose estimation. The fine camera pose estimation may be determined based on the analysis of the features. When the fine camera pose is determined, it is used to map texture onto the 3D model based on the aerial image.

A further understanding of the nature and the advantages of particular embodiments disclosed herein may be realized by reference of the remaining portions of the specification and the attached drawings.

### BRIEF DESCRIPTION OF THE DRAWINGS

The file of this patent contains at least one drawing executed in color. Copies of this patent with color drawings will be provided by the Patent and Trademark Office upon request and payment of the necessary fee.

FIG. 1 depicts an example of a computing device according to one embodiment.

FIG. 2 depicts a simplified flow chart of a method for mapping texture onto a 3D model according to one embodiment.

FIG. 3 depicts a more detailed example of determining the camera pose according to one embodiment.

FIG. 4 depicts a simplified flowchart of a method for determining feature point correspondence according to one embodiment.

FIG. 5A shows an example of a non-textured 3D model.

FIG. 5B shows an example of texture that has been mapped on the 3D model of FIG. 4A.

FIG. 6 shows an example of putative matches according to one embodiment.

FIG. 7 shows an output of putative matches after a Hough transform step.

FIG. 8 shows an output of putative matches after a GMSAC step.

### DETAILED DESCRIPTION OF EMBODIMENTS

3D models are needed for many applications, such as city planning, architectural design, telecommunication network design, cartography and fly/drive-thru simulation, etc. 3D model geometries without texture can be generated from LIDAR data. Particular embodiments map texture, such as color, shading, façade texture, onto the 3D model geometries based on aerial images. Oblique aerial images (e.g., photographs) covering wide areas are taken. These photos can cover both rooftop and the façade of buildings found in the area. An aerial image can then be used to automatically map texture onto the 3D model. However, a camera pose is needed to map the texture. Thus, particular embodiments automatically determine a camera pose based on the aerial image and the 3D model.

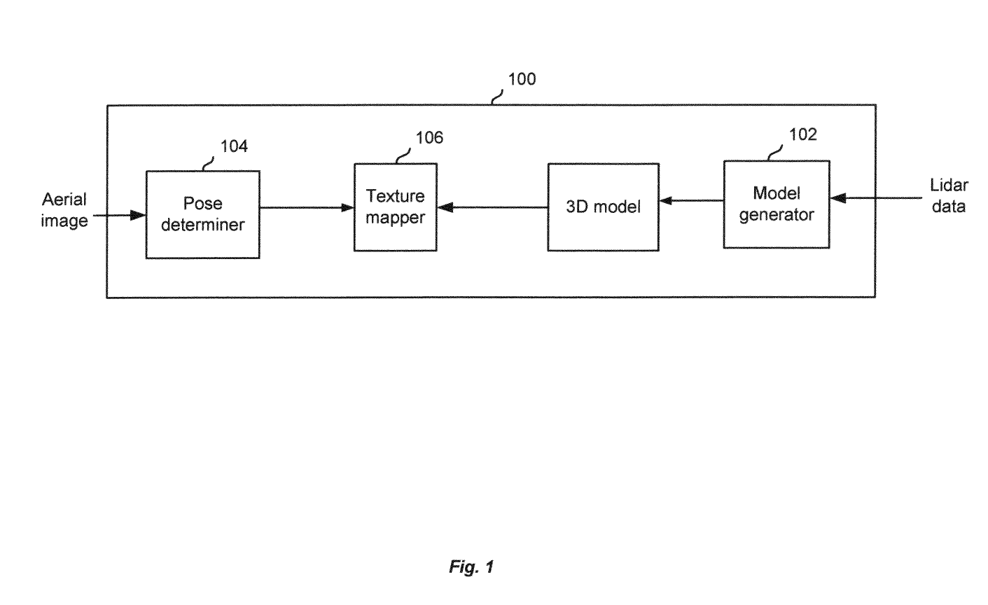

FIG. 1 depicts an example of a computing device 100 according to one embodiment. Computing device 100 may be a personal computer, workstation, mainframe, etc. Although functions are described as being performed by computer 100, it will be understood that some of those functions may be distributed to other computing devices.

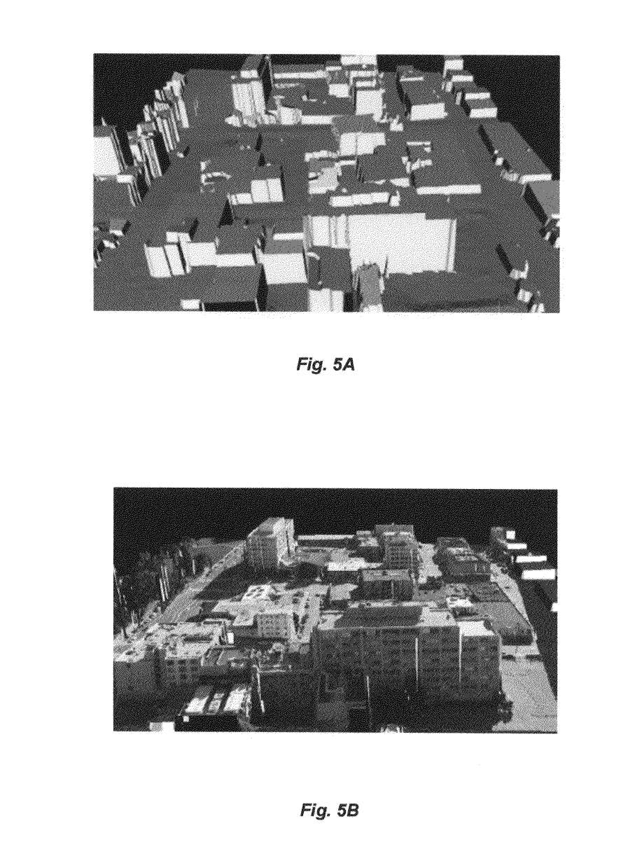

A model generator 102 is configured to generate a non-textured 3D model. The texture may be color, shading, etc. In one embodiment, the 3D model may be generated from LIDAR data. Also, other methods of generating the 3D model may be appreciated. FIG. 5A shows an example of a non-textured 3D model. As shown, geometries are shown that represent an area, such as a city, which includes structures, such as buildings, wildlife, etc. that are found in the area.

A pose determiner 104 is configured to determine a camera pose. The pose may be the position and orientation of the camera used to capture an aerial image of an area. The camera pose may include seven or more parameters, such as the x, y, and z coordinates, the angle (e.g. the yaw, pitch, and roll), and focal length. When the pose of the camera is determined, texture from an aerial image may be mapped onto the 3D model. Although a camera is described, it will be understood that any capture device may be used to capture an aerial image. For example, any digital camera, video camera, etc. may be used. Thus, any capture device that can capture a still image of an area may be used.

As will be described in more detail below, pose determiner 104 is configured to perform a coarse camera pose estimation and a fine camera pose estimation. The coarse camera pose parameters may be determined and then they are later refined into the fine camera pose estimate. For example, coarse camera pose parameters are determined using measurement information determined when a camera captured the aerial image. For example, global positioning system (GPS) and compass measurements may be taken when the aerial image was captured. The coarse estimates from the measurement device yield the x, y, z coordinates and the yaw angle. The focal length of the camera is also known. The other two angles of the camera pose, that is, the pitch and roll angles, are estimated from the detection of vanishing points in the aerial image. This can yield a coarse estimate of the camera pose. The estimate is coarse because some of the measurements have a level of inaccuracy and because of the accuracy needed to optimally map texture onto the 3D model, the coarse estimates may need to be refined.

In the refinement process, features in the aerial image and features in the 3D model are determined. For example, 2D orthogonal corner, or 2DOC, features are determined. At least of portion of these corners may be formed from geometries (e.g., corners formed by buildings) in the aerial image and the 3D model. 2DOCs correspond to orthogonal structural corners where two orthogonal building contour lines intersect. The 2DOCs for the 3D model and the 2DOCs from the aerial image are then superimposed on each other. Putative matches for the aerial image/3D model 2DOCs are then determined. The putative matches are refined to a smaller set of corresponding feature pairs. Once the 2D feature pairs are determined, a camera pose may be recovered.

Once the refined camera pose is determined, a texture mapper 106 may map the texture from the aerial image to the 3D model received from model generator 102. FIG. 5B shows an example of texture that has been mapped on the 3D model of FIG. 5A. For example, color and shading have been mapped onto the geometries of the 3D model. The process of mapping texture may be performed automatically once the camera pose is automatically determined. Also, it is efficiently performed in a matter of minutes instead of hours and results produced are accurate in generating a textured 3D model.

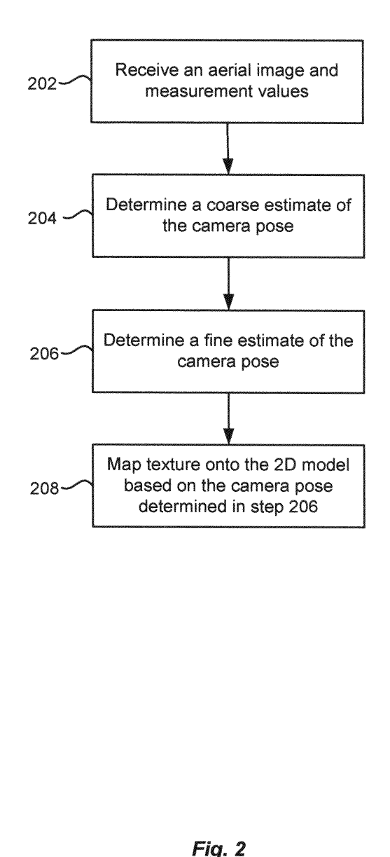

FIG. 2 depicts a simplified flow chart 200 of a method for mapping texture onto a 3D model according to one embodiment. Step 202 receives an aerial image and measurement values. Multiple aerial images may be received and may be registered to different 3D models. A registration may be automated or manual. For example, different aerial images may correspond to different portions of the 3D model. An aerial image is selected and the measurement values that were taken when the aerial image was captured are determined. For example, the x, y, and z coordinates, the focal length of the camera, and the yaw angle are determined. The x, y, and z coordinates are the location of the camera when an aerial image is captured. The focal length is how strongly the camera zooms in. Also, the yaw angle is a rotation with respect to the earth's magnetic north which the camera points at.

Step 204 determines a coarse estimate of the camera pose. For example, vanishing point detection may be used to determine the pitch and roll angles. A vanishing point may be a set of parallel lines in the 3D space which appear to intersect at a common point in the aerial image. The pitch may be the rotation around a lateral or transverse axis. That is, an axis running from left to right according to the front of the aircraft being flown. The roll may be the rotation around a longitudinal axis, as an axis drawn through the body of the aircraft from tail to nose and a normal direction of flight on the direction the aircraft is heading. Although vanishing points are described to determine the pitch and roll angles, it will be understood that other methods may be used to determine the pitch and roll angles.

A coarse estimate of the camera pose is determined based on the x, y, z, focal length, yaw angle, pitch angle and roll angle. This estimate is a coarse estimate because the x, y, z, and yaw angle that are determined from the measurement device may not be accurate enough to yield an accurate texture mapping. This yields an x, y, and z, and yaw angle that may not be as accurate as needed. Further, the vanishing point detection method may yield pitch and roll angles that may need to be further refined.

Thus, step 206 determines a fine estimate of the camera pose. A fine estimate of the camera pose is determined based on feature detection in the aerial image and 3D model. For example, 2DOC detection may be performed for the 3D model and also for the aerial image. The corners detected may be from structures, such as buildings, in both the 3D model and the aerial image. The detected corners from the aerial image and 3D model are then superimposed on each other. Putative matches for the corners are then determined. This determines all possible matches between pairs of corners. In one example, there may be a large number of putative corner matches. Thus, feature point correspondence is used to remove pairs that do not reflect the true underlying camera pose. This process may be performed in a series of steps that include a Hough transform and a generalized m-estimator sample consensus (GMSAC), both of which are described in more detail below. Once correct 2DOC pairs are determined, a camera pose may be recovered to obtain refined camera parameters for the camera pose.

Step 208 then maps texture onto the 3D model based on the camera pose determined in step 206. For example, based on the aerial image, texture is mapped on the 3D model using the camera pose determined. For example, color may be mapped onto the 3D model.

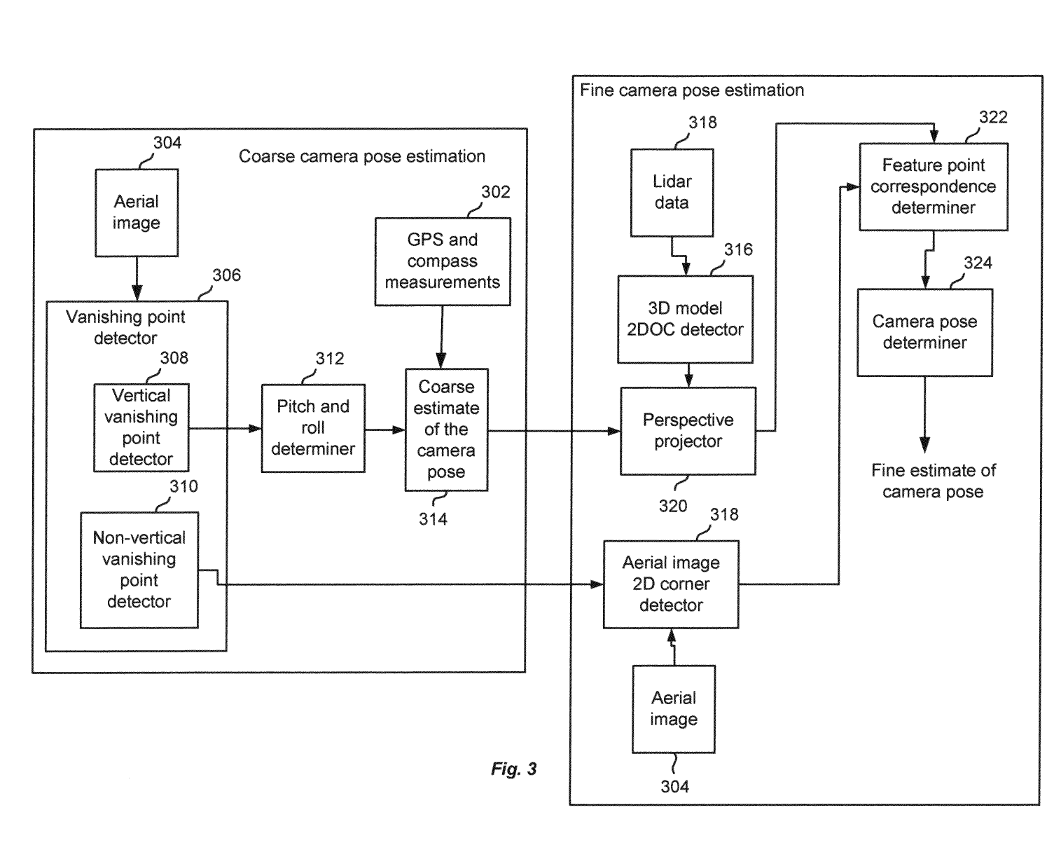

FIG. 3 depicts a more detailed example of determining the camera pose according to one embodiment. A GPS and compass measurement 302 is determined. The position and yaw angle of a camera may not be identified from the aerial image captured unless some landmarks, position of the sun, or shadows are considered. Thus, these parameters may be obtained from a measurement device when the aerial image is captured. For example, a GPS measurement device combined with an electronic compass may be used to determine the location and yaw angle of a camera when an aerial image is captured. When an image is taken, the image may be time-stamped. Also, the GPS and yaw angle readings may also be time-stamped. Thus, the location and compass reading may be correlated to an aerial image. In one embodiment, the location accuracy may be within 30 meters and the compass reading may be within 3 degrees. Although the roll and pitch angle are determined as described below using vanishing point detection, the GPS and compass measurement may be able to determine the roll and pitch angle. However, in some embodiments, the roll and pitch angle may not be as accurate as needed using the measurement device and thus vanishing point detection is used.

An aerial image 304 is received at a vanishing point detector 306. Vanishing points may be used to obtain camera parameters such as the pitch and roll rotation angles. A vertical vanishing point detector 308 is used to detect vertical vanishing points. The vertical vanishing points may be used to determine the pitch and roll angles. To start vanishing point detection, line segments from the aerial image are extracted. Line segments may be linked together if they have similar angles and their end points are close to each other.

In one embodiment, the vertical vanishing point is determined using a Gaussian sphere approach. A Gaussian sphere is a unit sphere with its origin at O_{c}, camera center. Each line segment on the image with O_{c} forms a plane intersecting the sphere to create a great circle. This great circle is accumulated on the Gaussian sphere. It is assumed that the maximum of the sphere represents the direction shared by multiple line segments and is a vanishing point.

In some instances, the texture pattern and natural city setting can lead to maxima on the sphere that do not correspond to real vanishing points. Accordingly, particular embodiments apply heuristics to distinguish real vanishing points. For example, only nearly vertical line segments on the aerial image are used to form great circles on the Gaussian sphere. This pre-selection process is based on the assumption that the roll angle of the camera is small so that vertical lines in the 3D space appear nearly vertical on an image. This assumption is valid because the aircraft, such as a helicopter, generally flies horizontally and the camera is held with little rolling. Once the maxima are extracted from the Gaussian sphere, the most dominant one at the lower half of the sphere is selected. This criterion is based on the assumption that all aerial images are oblique views (i.e., the camera is looking down), which holds for all acquired aerial images. After this process, the vertical lines that provide vertical vanishing points are determined.

Once the vertical vanishing points are detected, the camera's pitch and roll angles may be estimated. The vertical lines in the world reference reframe may be represented by e_{z}=[0,0,1,0]^{t} in a homogeneous coordinate. The critical vanishing point, v_{z} can be shown as:

λv_{z}=[−sin Ψ sin θ,−cos Ψ sin θ,−cos θ]^{T}

where λ is a scaling factor. Given the location of the vertical vanishing point, v_{z}, the pitch and roll angles and the scaling factor may be then calculated by a pitch and roll angle determiner 312 using the above equation. More specifically, arctangent of the ratio between the x component of v_{z} and y component of v_{z} gives roll angle. Once roll angle is known, arctangent of the x component of v_{z} divided by both sine of roll and z component of v_{z} gives pitch angle.

A non-vertical vanishing point detector 310 is configured to detect non-vertical vanishing points, such as horizontal vanishing points. These horizontal vanishing points may not be used for the coarse camera pose estimation but may be used later in the fine camera pose estimation.

Thus, a coarse estimate for the camera parameters of the camera pose is obtained. In one example, the coarse estimate may not be accurate enough for texture mapping. The camera parameters are refined so that the accuracy is sufficient for texture mapping. The fine estimate relies on finding accurate corresponding features in the aerial image and the 3D model. Once the correspondence is determined, the camera parameters may be refined by using the corresponding features to determine the camera pose.

In the fine camera pose estimation, a 3D model 2DOC detector 316 detects features in the 3D model. The features used by particular embodiments are corners, which are orthogonal structural corners corresponding to the intersections of two orthogonal lines. These will be referred to as 2DOCs. In one embodiment, these corners are particularly unique to city models and have limited numbers in a city model, which make them a good choice for feature matching. This is because 2DOCs may be more easily matched between the aerial image and the 3D model because of their distinctiveness. That is, the automatic process may be able to accurately determine correct 2DOC correspondence.

2DOC detector 316 receives LIDAR data 318. The 3D model may then be generated from the LIDAR data. For example, a digital surface model (DSM) may be obtained, which is a depth map representation of a city model. The DSM can also be referred to as the 3D model. To obtain 2DOCs, a building's structural edge is extracted from a 3D model. Standard edge extraction algorithms from image processing may be applied. However, a regional growing approach based on thresholding on height difference may be used. With a threshold on the height difference and the area size of a region, small isolated regions, such as cars and trees, may be replaced with ground-level altitude and objects on the rooftops such as signs and ventilation ducts are merged to the roof region. The outer contour of each region is then extracted. The lines may be jittery due to the resolution limitation from the LIDAR data. These lines may thus be straightened. From this, the position of 2DOCs may be determined. The 2DOCs that are determined are projected to the aerial image plane using the coarse camera parameters determined.

An aerial image 2DOC detector 318 detects 2DOCs from the aerial image. The 2DOCs in the aerial image may be determined using all the vanishing points detected. For example, orthogonal vanishing points with respect to each vanishing point are first identified. Each end point of a line segment belonging to a particular vanishing point is then examined. If there is an end point of another line belonging to an orthogonal vanishing point within a certain distance away, the midpoint of these two endpoints is identified as a 2DOC. The intersection between the two line segments may not be used because it can be far off from the real intersection because any inevitable slope angle error in a line segment can result in detrimental effect. This process is performed for every line segment in every vanishing point group. The 2DOCs are then extracted from the aerial image.

Accordingly, 2DOCs from the aerial image and the 3D model have been determined. Perspective projector 320 projects the 2DOCs from the 3D model onto the aerial image. Although the 2DOCs from the 3D model are projected on the aerial image, it will be understood that the 2DOCs from the aerial image may be projected onto the 3D model.

A feature point correspondence determiner 322 is then configured to determine 2DOC correspondence between the aerial image and the 3D model. The determination may involve determining putative matches and narrowing the putative matches into a set of 2DOC correspondence pairs that are used to determine the fine estimate of the camera pose. The method of determining a large set of putative matches and eliminating matches provides accurate correspondence pairs because all possible pairs are first determined and the correct pairs are used. If a large search radius is not used, some possible matches may not ever be considered, which may affect accuracy of the camera pose determined if they should have been considered pairs.

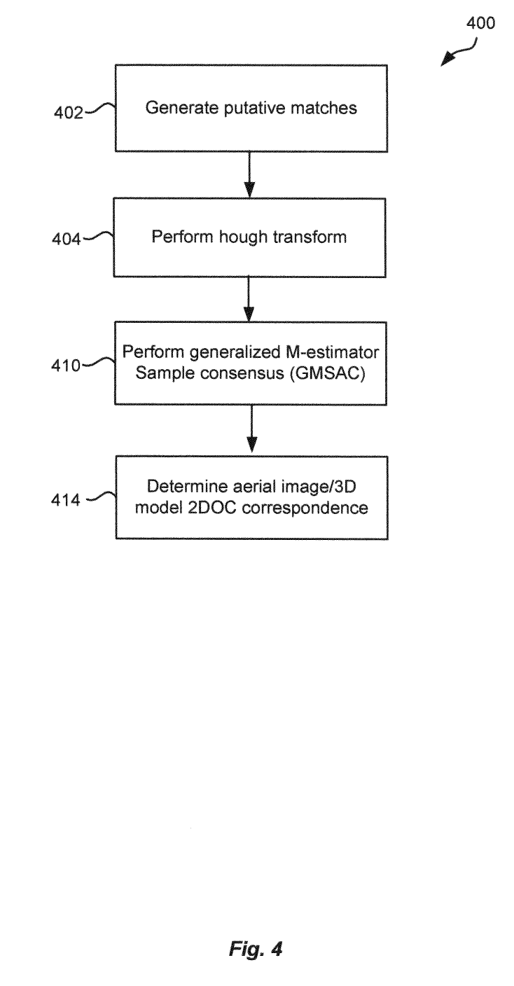

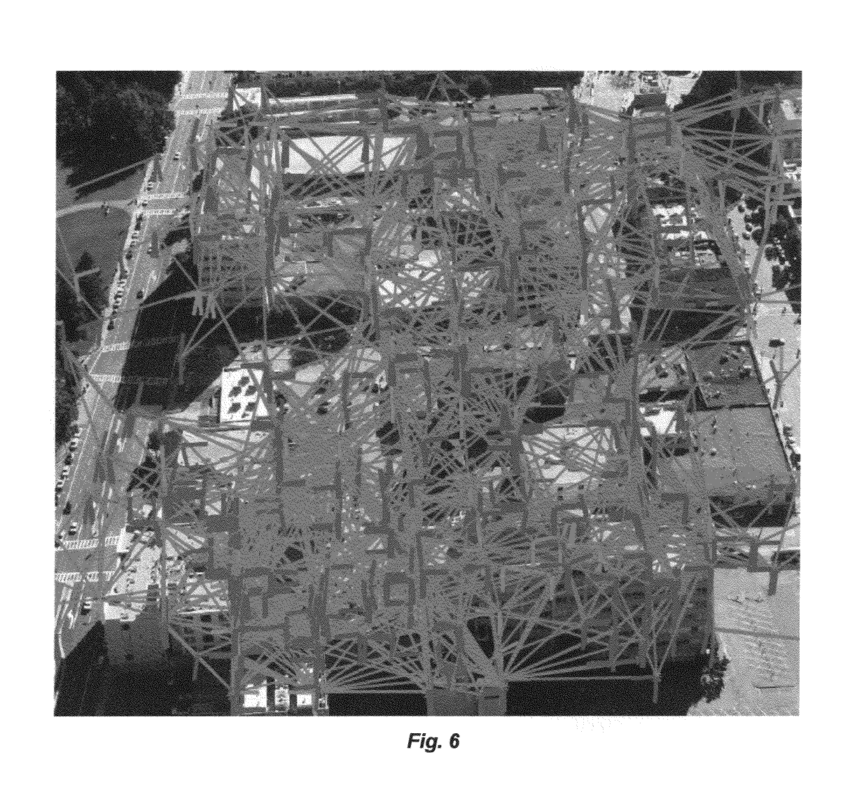

FIG. 4 depicts a simplified flowchart 400 of a method for determining feature point correspondence according to one embodiment. In step 402, putative matches from the 2DOCs from the aerial image and the 3D model are generated. The putative matches represent possible matches. FIG. 6 shows an example of putative matches according to one embodiment. The putative matches may be determined based on one or more criteria. For example, a putative match is determined based on a search radius and Mahalanobis distance of 2DOCs' characteristics. A search radius is used such as for every 2DOC detected in the 3D model, all 2DOCs from the aerial image within a certain search radius may be examined. A Mahalanobis distance based on the intersecting lines'angles of the 2DOCs may be computed and if it is within a threshold, a putative match is determined. Also, it is possible for there to be a 2DOC that has multiple other matches. For example, in FIG. 6, the blue lines represent a 2DOC for an aerial image and the green lines represent a 2DOC for the 3D model. The red lines indicate a link between a putative match. The search radius for putative matches may be large enough to accommodate inaccurate readings from the measurements and estimates from the vertical vanishing point. Thus, a large number of putative matches may be generated. For example, as shown, a large number of red lines are found. One example results in 3750 matches. This may create a tough burden to determine a fine estimate of the camera pose. Thus, processes are performed to narrow down the putative matches.

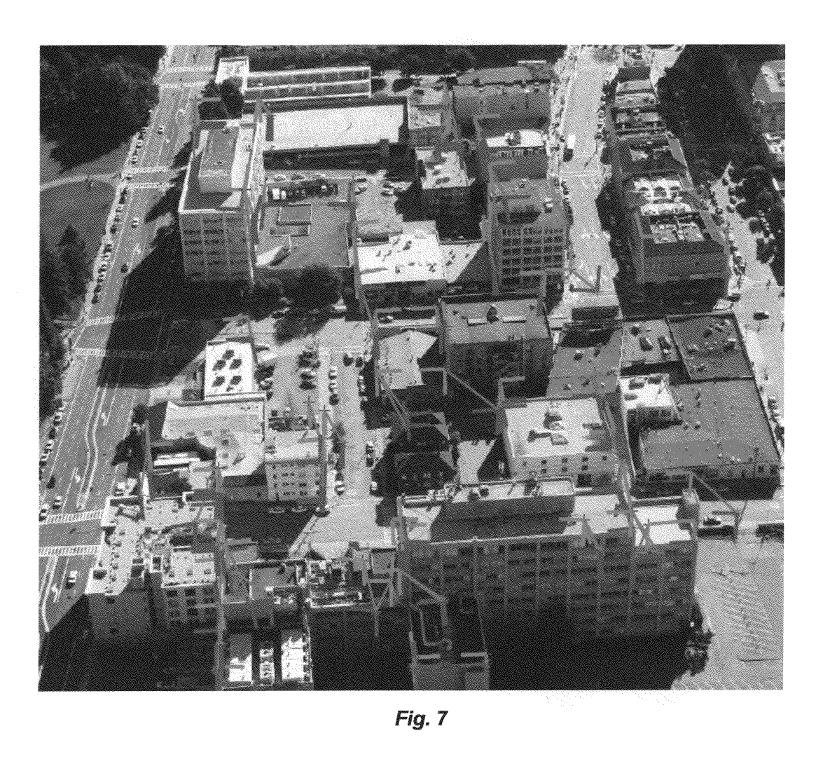

In step 404, a Hough transform is used to eliminate some of the putative matches. For example, a Hough transform is performed to find a dominant rotation angles between 2DOCs in the aerial image and the 3D model. The coarse camera parameters may be used to approximate the homographic relation between the 2DOCs for the aerial image and the 2DOCs for the 3D model as a pure rotational transformation. The output of the Hough transform results in about 200 putative matches as shown in FIG. 7. The number of lines connecting 2DOCs has been significantly reduced as about 3750 putative matches have been reduced to 200 putative matches.

The putative matches may then be narrowed further. For example, in step 406, a generalized m-estimator sample consensus (GMSAC) is used to eliminate additional putative matches. 2DOCs matching from two data sources among outliers may be a problem encountered. An outlier is an observation that is numerically distant from the rest of the data. GMSAC, a combination of generalized RANSAC and M-estimator Sample Consensus (MSAC) is used to further prune 2DOC matches. Generalized RANSAC is used to accommodate matches between a 3D model 2DOC and multiple image 2DOCs. MSAC is used for its soft decision, which updates according to the overall fitting cost and allows for continuous estimation improvement.

In the GMSAC calculation, the following steps may be determined:

1. Uniformly sample four groups of 2DOC matches for the 3D model and aerial image;

2. Inside each group, uniformly sample an image 2DOC;

3. Examine whether there are three co-linear points, degenerative case for homography fitting. If so, go to step 1.

4. With four pairs of 3D model/image 2DOC matches, a homography matrix, H, is fitted with the least squared error. A set of linear equations from the four pairs of matches can be formed. The equations are solved by singular value decomposition. The right single vector with the least significant singular value is chosen to be the homography matrix.

5. Every pair of 3D model/aerial image 2DOC matches in every group is then examined with the computed homography matrix where the sum of squared deviation instances is computed. The cost of each match is determined and a total number of inliers that have the cost below an error tolerance threshold and the sum of the costs from this particular homography matrix is determined.

6. If the overall cost is below the currently minimum cost, the inlier percentage is updated and the number of required iterations to achieve the desired confidence level is recomputed. Otherwise, another iteration is performed.

7. The program is terminated if the required iteration number is exceeded.

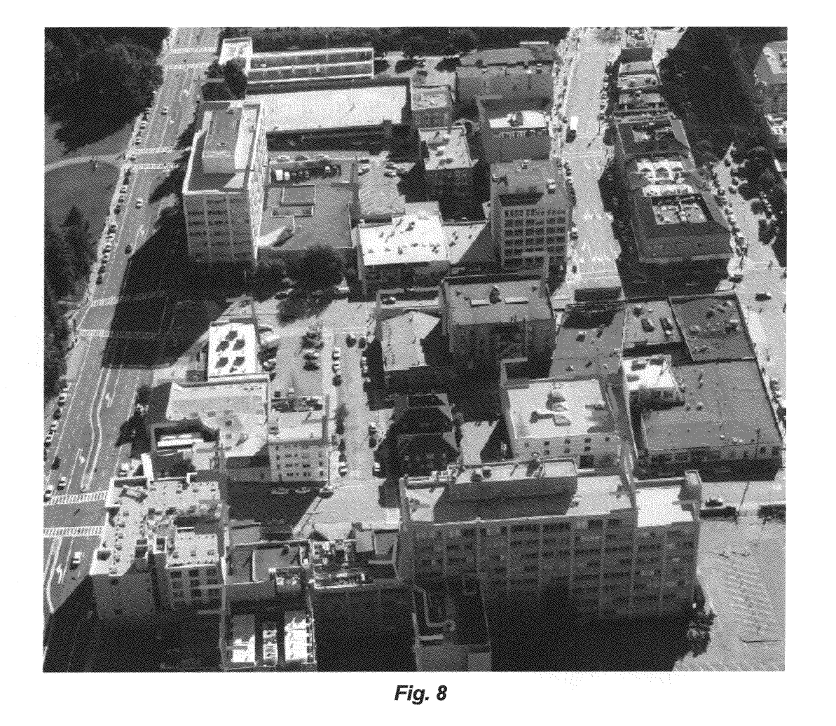

Accordingly, in one example, FIG. 8 shows 134 correct matches that are identified from GMSAC from greater than 200 matches from the Hough transform step. Thus, as can be seen from the progression from FIG. 6 to FIG. 8, the number of putative matches has been reduced. An accurate correspondence between aerial image/3D model 2DOCs has been determined. Accordingly, features in the aerial image and the 3D model were automatically detected. A correspondence between the features was then determined. The correspondence is determined by finding a large number of putative matches and then eliminating matches, which provides an accurate correspondence between features.

Referring back to FIG. 3, a 3D model/aerial image 2DOC correspondence is output to a camera pose determiner 324. This includes all identified 2DOC correspondence pairs. A camera pose recovery determiner 324 is configured to determine a fine estimate of the camera pose. For example, a Lowe's camera pose recovery algorithm is performed on all identified corner correspondence pairs. The Lowe's camera pose recovery algorithm takes the positions of the image 2DOCs and the positions of the corresponding 3D model 2DOCs and applies Newton's method to iteratively search for optimal camera parameters in order to minimize distances between the projected 3D model 2DOCs and the image 2DOCs. This provides a more accurate set of camera parameters for the camera pose.

Once the fine estimate of the camera pose is determined, texture mapping from the aerial image to the 3D model may be performed. In one embodiment, standard texture mapping is used based on the fine estimate of the camera pose that is automatically determined in particular embodiments. Thus, the estimate of the camera pose is automatically determined from the aerial image and the 3D model. Manual estimation of feature correspondence may not be needed in some embodiments.

Although the description has been described with respect to particular embodiments thereof, these particular embodiments are merely illustrative, and not restrictive. Although city models are described, it will be understood that models of other areas may be used.

Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

Particular embodiments may be implemented in a computer-readable storage medium for use by or in connection with the instruction execution system, apparatus, system, or device. Particular embodiments can be implemented in the form of control logic in software or hardware or a combination of both. The control logic, when executed by one or more processors, may be operable to perform that which is described in particular embodiments.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

We claim:

1. A method for mapping texture on 3D models, the method comprising:
determining an aerial image of an area;
determining a 3D model for the aerial image;
automatically analyzing features of the aerial image and the 3D model to determine feature correspondence of features from the aerial image to features in the 3D model; and
determining a camera pose for the aerial image based on the analysis of the feature correspondence, wherein the camera pose allows texture to be mapped onto the 3D model based on the aerial image.

2. The method of claim 1, wherein automatically analyzing features comprising:
determining a coarse camera pose estimation; and
determining a fine camera pose estimation using the coarse camera pose estimation to determine the camera pose.

3. The method of claim 2, wherein determining the coarse camera pose estimation comprises detecting vanishing points in the aerial image to determine a pitch angle and roll angle.

4. The method of claim 3, wherein determining the coarse camera pose comprising:
determining location measurement values taken when the aerial image was captured to determine x, y, z, and yaw angle measurements.

5. The method of claim 2, wherein performing the fine camera pose estimation comprises:
detecting first corner features in the aerial image;
detecting second corner features in the 3D model; and
projecting the first corner features with the second corner features.

6. The method of claim 5, further comprises:
determining putative matches between first corner features and second corner features; and
eliminating matches in the putative matches to determine a feature point correspondence between first corner features and second corner features.

7. The method of claim 6, wherein eliminating matches comprises performing a Hough transform to eliminate a first set of matches in the putative matches to determine a refined set of putative matches.

8. The method of claim 7, wherein eliminating matches comprises performing a generalized m-estimator sample consensus (GMSAC) on the refined set of putative matches to eliminate a second set of matches in the refined set of putative matches to generate a second refined set of putative matches.

9. The method of claim 8, wherein determining the camera pose comprises using the second refined set of putative matches to determine the camera pose.

10. Software encoded in one or more computer-readable media for execution by the one or more processors and when executed operable to:
determine an aerial image of an area;
determine a 3D model for the aerial image;
automatically analyze features of the aerial image and the 3D model to determine feature correspondence of features from the aerial image to features in the 3D model; and
determine a camera pose for the aerial image based on the analysis of the feature correspondence, wherein the camera pose allows texture to be mapped onto the 3D model based on the aerial image.

11. The software of claim 10, wherein the software operable to automatically analyze features comprises software that when executed is operable to:
determine a coarse camera pose estimation; and
determine a fine camera pose estimation using the coarse camera pose estimation to determine the camera pose.

12. The software of claim 11, wherein the software operable to determine the coarse camera pose estimation comprises software that when executed is operable to detect vanishing points in the aerial image to determine a pitch angle and roll angle.

13. The software of claim 12, wherein the software operable to determine the coarse camera pose comprises software that when executed is operable to determine location measurement values taken when the aerial image was captured to determine x, y, z, and yaw angle measurements.

14. The software of claim 11, wherein the software operable to perform the fine camera pose estimation comprises software that when executed is operable to:
detect first corner features in the aerial image;
detect second corner features in the 3D model; and
project the first corner features with the second corner features.

15. The software of claim 14, wherein the software when executed is further operable to:
determine putative matches between first corner features and second corner features; and
eliminate matches in the putative matches to determine a feature point correspondence between first corner features and second corner features.

16. The software of claim 15, wherein the software operable to eliminate matches comprises software that when executed is operable to perform a Hough transform to eliminate a first set of matches in the putative matches to determine a refined set of putative matches.

17. The software of claim 16, wherein software operable to eliminate matches comprises software that when executed is operable to perform a generalized m-estimator sample consensus (GMSAC) on the refined set of putative matches to eliminate a second set of matches in the refined set of putative matches to generate a second refined set of putative matches.

18. The software of claim 17, wherein software operable to determine the camera pose comprises software that when executed is operable to use the second refined set of putative matches to determine the camera pose.

19. An apparatus configured to map texture on 3D models, the apparatus comprising:
means for determining an aerial image of an area;
means for determining a 3D model for the aerial image;
means for automatically analyzing features of the aerial image and the 3D model to determine feature correspondence of features from the aerial image to features in the 3D model; and
means for determining a camera pose for the aerial image based on the analysis of the feature correspondence, wherein the camera pose allows texture to be mapped onto the 3D model based on the aerial image.

20. The apparatus of claim 19, wherein means for automatically analyzing features comprising:
means for determining a coarse camera pose estimation; and
means for determining a fine camera pose estimation using the coarse camera pose estimation to determine the camera pose.
